(19) United States
(12) Patent Application Publication
(10) Pub. No.: US 2011/0060600 A1
(43) Pub. Date: Mar. 10, 2011

(54) Systems and Methods For Tracking the Transportation of Passengers

(75) Inventors: Arieh Fox, Teaneck, NJ (US); Benjamin Fox, Teaneck, NJ (US)

(73) Assignee: TRANSITTIX, LLC, Ridgefield Park, NJ (US)

(21) Appl. No.: 12/557,161

(22) Filed: Sep. 10, 2009

(51) Int. Cl. G06Q 50/00; G08B 13/14; G01S 19/51

(52) U.S. Cl. 705/1.1; 340/572.1; 342/357.34

(57) ABSTRACT

Advantageous systems and methods are provided for tracking the transportation of passengers. In general, the systems and methods utilize GPS signals associated with each of a passenger and a transportation vehicle to determine at least one of: (i) a start point for the passenger traveling via the transportation vehicle and (ii) an end point for the passenger traveling via the transportation vehicle. The determination of the start and/or end points for the passenger traveling via the transportation vehicle may advantageously facilitate ticketing, e.g., by automatically validating/calculating trip cost, trip duration, trip distance, etc.

### BACKGROUND

1. Technical Field

The present disclosure relates to systems and methods for tracking the transportation of passengers, e.g., for facilitating electronic ticketing.

2. Background Art

Electronic ticketing (or e-ticketing) is rapidly replacing paper-based ticketing as the preferred means for controlling/monitoring the influx of passengers on various forms of transportation. Electronic ticketing offers many advantages over its paper-based counterpart, particularly in the area of accessibility. Specifically, whereas paper-based tickets require ticketing hubs/stations, e-tickets are easily produced, monitored, accessed, transferred, redeemed, etc., all over a network.

Consequently, electronic ticketing is revolutionizing the types of transactions/exchanges which are possible. For instance, Japanese patent publication No. 2000/123730 discloses a paperless ticket system including a reservation receiving system and admission management systems. The reservation receiving system advantageously receives a ticket reservation from a portable telephone set, stores the identification number of the portable telephone set and ticket reservation information in a reservation information database, and transmits authentic-able data corresponding to the ticket reservation information to the portable telephone set. The admission management systems receive the authentic-able data from the portable telephone set and confirm a reservation/manage admission by authenticating the authentic-able data. In this respect, a portable telephone set may function as both a ticketing kiosk, for purchasing a ticket, and the ticket for gaining entry.

Recent years have seen the development and implementation of various systems and methods using radio frequency (RF) and other wireless technologies to facilitate electronic ticketing. One example of such is the recent implementation of the Automated Fare Collection System (AFCS) in Massachusetts by the Massachusetts Bay Transportation Authority (MBTA). The system utilizes a radio frequency identification (RFID) based “smart-card” (called the CharlieCard) for electronic ticketing. Each card can store value (i.e., a cash balance), trip information (including transfers), and other information (such as time-based passes which allow unlimited rides during a set period of time). Passengers use the card by bringing it into proximity with a target on a gate or a vehicle fare-box. The gate/fare-box then automatically debits the cost of the passenger's ride, verifies that the card has a valid transfer, or verifies that the card has a pass that is valid for travel at that time at that particular location.

The AFCS and other smart-card based systems are not, however without their limitations. Such systems are typically “off-line” (i.e., not network-based) which limits accessibility. Thus, while transit riders on the MBTA can add value and/or passes to their cards at various kiosks located at MBTA stations and vehicles, MBTA ticket offices, etc., access remains localized. Furthermore, ticket validation is based on a single point of reference at a discrete moment in time (i.e., the tapping of the RFID card on the sensor). Therefore, to obtain complete trip information (i.e., start and end points) gates/fare-boxes are required both at points of entry and exit. Such points of entry and exit add to passenger congestion and delay.

Another disadvantage of conventional RFID-based technology is illustrated by analyzing the E-ZPass electronic toll collection system in the northeastern United States. The E-ZPass system utilizes a battery powered RFID transponder, much the same way as the AFCS utilizes a smart-card. The transponder communicates with reader equipment built into lane-based or open road-based toll collection points. Unfortunately, the reliability of the transponder and reader equipment is not one-hundred percent. Thus, since validation is again based on a single point of reference at a discrete moment in time (i.e., driving passed the toll), instances are frequently missed. Missed instances often results “open” trips (i.e., missing a starting or end point) being reported, wherein either the passenger is charged the maximum trip amount (often greater than the actual fare) or the transportation provider losses revenue.

Given the pervasiveness of mobile devices (e.g., cell phones) efforts have been made to transform such mobile device into essentially smart cards or RFID transponders. Such efforts have largely focused on utilizing RF (i.e., BlueTooth) technologies. Despite efforts to date, however, there remains a need to address/overcome the disadvantages of conventional RFID-based systems. These and other needs are satisfied by the systems and methods of the present disclosure.

### SUMMARY

Advantageous systems and methods are provided herein for tracking the transportation of passengers. In general, the systems and methods utilize GPS signals associated with each of a passenger and a transportation vehicle to determine at least one of: (i) a start point for the passenger traveling via the transportation vehicle and (ii) an end point for the passenger traveling via the transportation vehicle. The determination of the start and/or end points for the passenger traveling via the transportation vehicle may advantageously facilitate ticketing, e.g., by automatically validating/calculating trip cost, trip duration, trip distance, etc.

Systems, accordingly to the present disclosure, may typically include a base station associated with a transportation vehicle and a mobile device associated with a passenger of the transportation vehicle, wherein the base station and the mobile device each include a Global Positioning System (GPS) tracking unit. Thus, the base station GPS tracking unit may be advantageously configured to detect location data for the transportation vehicle and the mobile device GPS tracking unit may be advantageously configured to detect location data for the passenger (thereby providing the pair of continuous points of reference). The base station and the mobile device may each be configured to transmit the transportation vehicle location data and the passenger location data to a processor, e.g., a server which may be configured to monitor a relative position of the passenger relative to the transportation vehicle. The relative position of the passenger relative to the vehicle may then be used to determine at least one of: (i) a start point for the passenger traveling via the transportation vehicle and (ii) an end point for the passenger traveling via the transportation vehicle, e.g., for facilitating ticketing.

Similarly, methods, according to the present disclosure, generally involve the same system architecture and may typically include the following steps:
using a mobile device, associated with a passenger and including a Global Positioning System (GPS) tracking unit, to detect location data for the passenger;
using a base station, associated with a transportation vehicle and including a GPS tracking unit, to detect location data for the transportation vehicle;
transmitting the passenger location data and the transportation vehicle location data to a processor, e.g., a server;
using the passenger location data and the transportation vehicle location data to monitor a relative position of the passenger relative to the transportation vehicle; and
using the relative position of the passenger relative to the vehicle to determine at least one of: (i) a start point for the passenger traveling via the transportation vehicle and (ii) an end point for the passenger traveling via the transportation vehicle.

Additional features, functions and benefits of the disclosed systems and methods will be apparent from the description which follows, particularly when read in conjunction with the appended figures.

### BRIEF DESCRIPTION OF THE DRAWINGS

To assist those of ordinary skill in the art in making and using the disclosed optical assemblies, reference is made to the appended figures, wherein:

FIG. 1 depicts an exemplary system for tracking the transportation of passengers, according to the present disclosure.

FIG. 2 depicts an exemplary implementation of the system of FIG. 1.

### DESCRIPTION OF EXEMPLARY EMBODIMENT(S)

Advantageous systems and methods are provided, according to the present disclosure for tracking the transportation of passengers. In particular, the present systems and methods enable the determination of at least one of: (i) a start point for a passenger traveling via a transportation vehicle and (ii) an end point for a passenger traveling via a transportation vehicle. Thus, the present systems and methods provide similar information to that traditionally obtained by conventional RFID passenger tracking technologies. According to the present disclosure, the start and/or end point information may be advantageously used to facilitate ticketing, e.g., by automatically validating e-tickets and/or calculating ticket information such as trip cost based on one or more of trip duration, trip distance, trip expenses (such as fuel use and tolls) over the course of a trip, etc.

While the present systems and methods may yield information similar to that traditionally provided by conventional RFID tracking technology, the architecture and implementation of the present systems and methods is significantly different than such conventional systems. Specifically, the systems and methods of the present disclosure utilize independent GPS signals associated with each of a passenger and a transportation vehicle to determine location data for each. Contrasted with conventional RFID technology, which provides only a single discrete point of reference (i.e., based on the proximity of an RFID tag to a receiving antenna), the present systems and methods advantageously provide for the continuous detection and monitoring of the GPS signals associated with each of the passenger and the transportation vehicle. Thus, the present systems and methods utilize a pair of streaming points of reference which may be independently monitored regardless of proximity. These streaming points of reference alleviate many of the reliability issues characteristic of RFID systems (in particular, the present systems and methods are not reliant on discrete detection events, such as the swiping of an RFID card, but rather determine the occurrence of such events from a greater data set obtained via the continuous detection and monitoring of the pair of GPS signals).

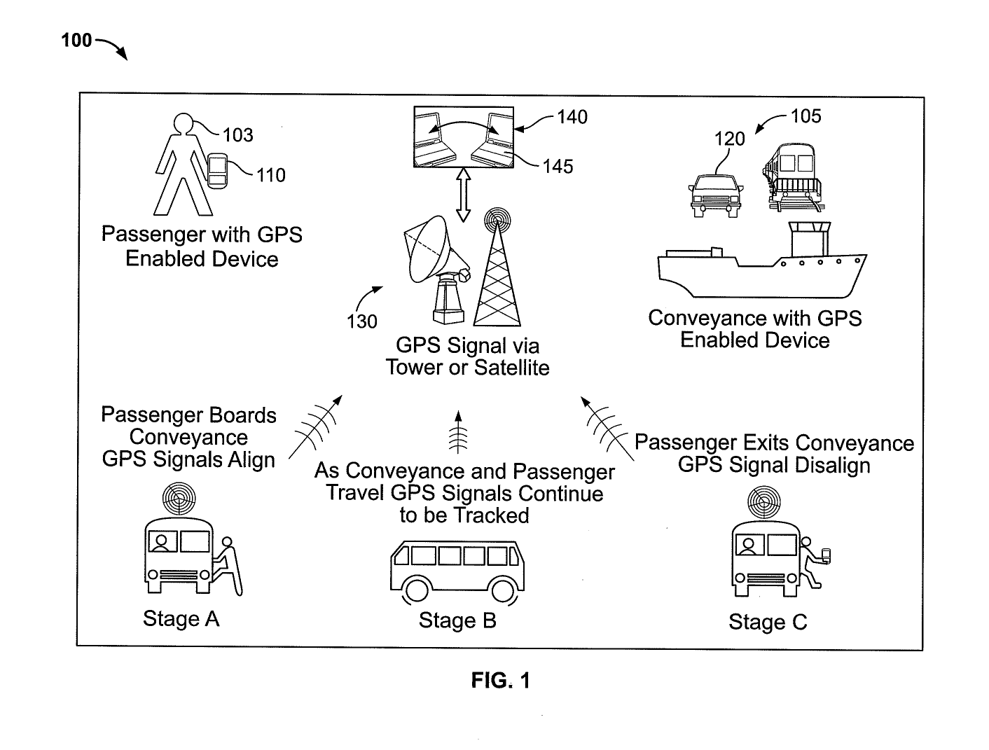

Referring now to FIG. 1, an exemplary passenger tracking system 100 is depicted. The passenger tracking system 100 advantageously includes a mobile device 110, such as a cell phone, a PDA, a navigation system, etc. The mobile device 110 is GPS enabled and typically includes a GPS tracking unit configured to provide a GPS signal. The mobile device is advantageously associated with a passenger 103 or a group of passengers as the case may be. In some instances, the mobile device 110 may be associated with a item being transported along with a passenger. For example, the mobile device 110 may be a navigation system in a passenger's car wherein the passenger and the car are being transported via a ferry. The GPS tracking unit is typically configured to detect location data for the passenger 103. Thus, the GPS tracking unit may be configured to cooperate with a communication system 130, e.g., a cell-based (tower-based) communication system, a satellite-based communications system etc. to determine the passenger location data. The passenger location data may be advantageously transmitted via a network 140 associated with a communications system 130 to a server 145 for further processing and analysis as described herein.

As described above, the mobile device 110 need not be a dedicated component of the passenger tracking system 100. Indeed, the GPS-enabled mobile device may be primarily a personal mobile device such as a cell phone or PDA which in most instances is not associated/connected with passenger tracking system 100. Thus, the mobile device 110 may include an enabling feature such as a mobile application for associating/connecting the mobile device 110 to the passenger tracking system 100. The mobile device 110 may further include features/applications for facilitating ticketing transactions. Thus, for example the mobile device 110 may receive, store, process, and transmit identification information, payment information and other transaction related information.

The passenger tracking system 100 also advantageously includes a base station 120 associated with a transportation vehicle/conveyance 105. The transportation vehicle/conveyance may 105 be any vehicle/conveyance used in passenger transportation including but not limited to a bus, a taxi, a train, a subway, a ferry, a plane, etc. Like the mobile device 110 the base station 120 is GPS enabled and typically includes a GPS tracking unit configured to provide a GPS signal and detect location data for the vehicle/conveyance 105. The vehicle location data may be transmitted via a network 140 associated with a communications system 130 to the server 145 for further processing and analysis as described herein. Note that, as described herein, the network 140 and communications system 130 used in the detection and transmitting of location data to the server 145 may be a single network and communications system or a plurality of networks and communications systems.

Exemplary passenger tracking system 100 of the present disclosure is advantageously network-based and therefore includes a central server 145 (or group of servers) for receiving, storing, processing and transmitting transportation and ticketing related information. The server-based architecture of the passenger tracking system 100 yields many advantages over traditional non-server based systems. Transportation data, e.g. related to passenger volume, delays, etc. may be monitored on a continuous basis and may be used, e.g., to respond to developing needs and conditions. The server-based architecture also promotes accessibility via any device that may be networked into the passenger tracking system 100. In this respect the passenger tracking system 100 may utilize infrastructure which is already in place, e.g., cell phones, PDAs, navigation systems, etc, in achieving implementation. It is noted, that while exemplary passenger tracking system 100 includes a central server the tracking system according to the present disclosure may also be non-network-based and therefore process the information locally, e.g., via any one or more processors associated with the mobile device, the base station or both the mobile device and the base-station.

Referring still to the exemplary embodiment depicted in FIG. 1, upon the server 145 receiving the passenger location and vehicle location data, the sever 145 may be advantageously configured to monitor a relative position of the passenger 103 relative to the transportation vehicle 105. Thus, the server 145 may be configured to determine, based on the relative position of the passenger 103 relative to the vehicle 105 at least one of: (i) a start point for the passenger traveling via the transportation vehicle (e.g., based on the passenger and vehicle GPS signals aligning for a given distance and/or time) and (ii) an end point for the passenger traveling via the transportation vehicle (e.g., based on the passenger and vehicle GPS signals misaligning for a given distance and/or time).

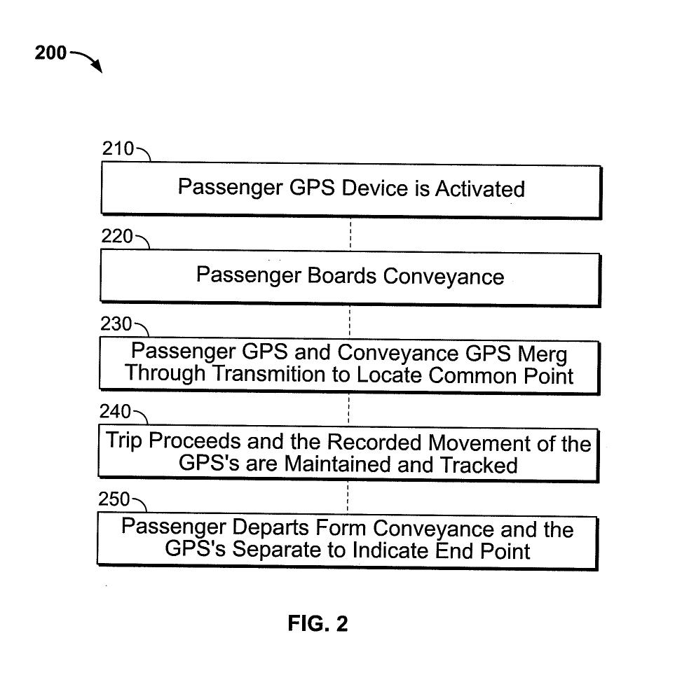

With reference now to FIGS. 1 and 2 an exemplary implementation 200 of passenger tracking system 100 is depicted. At step 210 a passenger 103 activates the GPS tracking unit associated with the GPS-enabled mobile device 110, e.g., using an enabling feature. The passenger 103 may also use other applications/features on the mobile device to initiate a ticketing transaction. In exemplary embodiments, the passenger 103 may designate a start and/or stop point, payment information, travel times, passenger information (including number of passengers), etc. Thus, the passenger 103 may finalize a reservation for transportation via a specific transportation vehicle 105. The activation of the GPS tracking unit connects the mobile device 110 to the passenger tracking system 100 such that passenger 103 location data is streamed to the server 145. The server 145 monitors the relative position of the passenger 103 relative to the passenger vehicle 105.

At step 220 the passenger 103 (or designated group of passengers) boards the transportation vehicle 105 causing the passenger location and vehicle location to align at the server 145 (step 230). Upon the passenger 103 and vehicle 105 location data aligning, a ticket confirmation may be communicated to the mobile device 110 and/or base station 120 to facilitate ticket validation and authorize boarding. The ticket confirmation may advantageously indicate information such as the number of start/stop point, number of passengers, etc. Over Stage A (e.g., for a given time and/or distance) the server 145 continues to monitor the alignment to ensure that the passenger 103 has boarded the vehicle 105. Upon determination that the passenger 103 has indeed boarded the vehicle 105, information related to the start point of the trip, e.g., start location, start time, etc., is recorded at the server 145.

At step 240 and over Stage B the passenger 103 is transported via the transportation vehicle 105 and the server 145 continues to monitor the alignment of the GPS signals. This continuous stream of data provides “last known” positions/headings for each of the passenger 103 and vehicle 105. This “last known” position/heading data may be used, e.g., to extrapolate end of trip information should either of the signals be disconnect for a period of time. At step 250 the passenger 103 exists the vehicle 105 causing the GPS passenger location and vehicle location to misalign. Over Stage C (e.g., for a given time and/or distance) the server 145 continues to monitor the misaligned signals to ensure that the passenger 103 has departed from the transportation vehicle 105. Upon determination that the passenger 103 has departed the vehicle 105, information related to the end point of the trip, e.g., start location, start time, etc., is recorded at the server 145.

As previously discussed, the start and/or end point information may be advantageously used to facilitate ticketing, e.g., by automatically validating/calculating ticket information Thus, for example the start and/or end point information may be used to validate that the passenger 103 boarded and departed the transportation vehicle 105 at the locations specified in the ticket information. According to the present disclosure, the start and/or endpoint information may also be used to implement novel pricing on mass transportation systems, e.g., meter-based (i.e., time and/or distance-based) pricing. Furthermore pricing may be offset relative to actual (i.e. real time) costs such as fuel expenditure, etc.

It is appreciated that the passenger tracking system 100 of the present disclosure may be implemented independent of or in conjunction with a traditional RFID tracking system. Thus, in exemplary embodiments the mobile device 110 may be configured to function as an RFID transponder (e.g., using a Bluetooth connection) cable of communicating directly with the base station 120 associated with the transportation vehicle 105. Such RFID-based communication may be used in conjunction with the monitoring of the GPS signals to validate/determine the start and/or end points of a trip. Thus, in exemplary embodiments, the RFID-based communication may be used to validate/authorize boarding while the monitoring of the GPS signals may be used to determine departure information. In further exemplary embodiments, the RFID-based communications may be used to transmit ticketing information, such as start and stop points and number of passengers, from the mobile device 110 to the base station 120 for review/validation.

System Implementations:

It is explicitly contemplated that the above systems and methods may be carried out, e.g., via a mobile device, base station and one or more processing units having associated therewith appropriate software, firmware and/or hardware. The processing unit(s) of the present disclosure, generally, include means, e.g., hardware, firmware or software, for carrying out the above process of calibration/normalization. In exemplary embodiments, the hardware, firmware and/or software may be provided, e.g., as upgrade module(s) for use in conjunction with existing infrastructure (e.g., existing devices/processing units). Software/firmware may, e.g., advantageously include processable instructions, i.e. computer readable instructions, on a suitable storage medium for carrying out the above process. Similarly, hardware may, e.g., include components and/or logic circuitry for carrying out the above process.

Displays and/or other feedback means may also be included to convey detected/processed data. Thus, in exemplary embodiments, passenger locations and vehicle locations may be displayed, e.g., on a monitor. The display and/or other feedback means may be stand-alone or may be included as one or more components/modules of the processing unit(s). In exemplary embodiments, the display and/or other feedback means may be used to facilitate routing a transportation vehicle to a passenger requiring transportation services.

In general, it will be apparent to one of ordinary skill in the art that various embodiments described herein may be implemented in, or in association with, many different embodiments of software, firmware and/or hardware. The actual software code or specialized control hardware which may be used to implement some of the present embodiments is not intended to limit the scope of such embodiments. For example, certain aspects of the embodiments described herein may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments may be described without specific reference to the actual software code or specialized hardware components. The absence of such specific references is feasible because it is clearly understood that artisans of ordinary skill would be able to design software and control hardware to implement the various embodiments based on the description herein with only a reasonable effort and without undue experimentation.

Moreover, the systems and methods of the present disclosure may be executed by, or in operative association with, programmable equipment, such as computers and computer systems. Software that cause programmable equipment to execute the methods may be stored in any storage device, such as, for example, a computer system (non-volatile) memory, an optical disk, magnetic tape, or magnetic disk. Furthermore, the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, decoded and executed by a computer.

It can also be appreciated that certain steps described herein may be performed using instructions stored on a computer-readable medium or media that direct a computer system to perform said steps. A computer-readable medium may include, for example, memory devices such as diskettes, compact discs of both read-only and read/write varieties, optical disk drives and hard disk drives. A computer-readable medium may also include memory storage that may be physical, virtual, permanent, temporary, semi-permanent and/or semi-temporary. A computer-readable medium may further include one or more data signals transmitted on one or more carrier waves.

A “processor,” “processing unit,” “computer” or “computer system” may be, for example, a wireless or wireline variety of a microcomputer, minicomputer, server, mainframe, laptop, personal data assistant (PDA), wireless e-mail device (e.g., “BlackBerry” trade-designated devices), cellular phone, pager, processor, fax machine, scanner, or any other programmable device configured to transmit and receive data over a network. Computer systems disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM) and other computer-readable media.

Although the present disclosure has been described with reference to exemplary embodiments and implementations thereof, the disclosed passenger tracking systems and methods are not limited to such exemplary embodiments/implementations. Rather, as will be readily apparent to persons skilled in the art from the description provided herein, the disclosed systems and methods are susceptible to modifications, alterations and enhancements without departing from the spirit or scope of the present disclosure. Accordingly, the present disclosure expressly encompasses such modification, alterations and enhancements within the scope hereof.

What is claimed:

1. A system for tracking transportation of passengers the system comprising:
a. a base station associated with a transportation vehicle;
b. a mobile device associated with a passenger of the transportation vehicle; and
c. a processor;
wherein the base station and the mobile device each include a Global Positioning System (GPS) tracking unit, the base station GPS tracking unit configured to detect location data for the transportation vehicle and the mobile device GPS tracking unit configured to detect location data for the passenger;
wherein the base station and the mobile device are configured to transmit the transportation vehicle location data and the passenger location data to the processor, whereby the processor is configured to monitor a relative position of the passenger relative to the transportation vehicle; and
wherein the relative position of the passenger relative to the vehicle is used to determine information relating to at least one of: (i) a start point for the passenger traveling via the transportation vehicle and (ii) an end point for the passenger traveling via the transportation vehicle.

2. The system according to claim 1, wherein the information relating to the start or end point is used to validate or calculate ticket information.

3. The system according to claim 2, wherein the ticket information includes at least one of trip duration, trip distance, and trip expenses.

4. The system according to claim 3, wherein the trip cost is validated or calculated based the ticket information.

5. The system according to claim 1, wherein the mobile device is one of a cell phone, a PDA, and a navigation system.

6. The system according to claim 1, wherein the mobile device is associated with a group of passengers.

7. The system according to claim 1, wherein the mobile device is not a dedicated component of the system.

8. The system according to claim 1, wherein the mobile device includes an enabling feature for associating the mobile device with the system.

9. The system according to claim 1, wherein the mobile device further includes ticketing transaction features, wherein the mobile device at least one of receives, stores, processes, and transmits transaction related information.

10. The system according to claim 9, wherein the passenger uses the ticketing transaction features to initiate a ticketing transaction.

11. The system according to claim 10, wherein the passenger initiates a ticketing transaction be designating at least one of a start point, a stop point, payment information, travel times, and passenger information including number of passengers.

12. The system according to claim 1, wherein upon the passenger boarding the transportation vehicle an alignment of the passenger location and vehicle location at the processor results in a ticket confirmation being communicated to the mobile device to facilitate ticket validation and authorize boarding.

13. The system according to claim 1, wherein the relative position is used to determine a last known position and a last know heading for each of the passenger and the transportation vehicle, wherein said last known position and last known heading is used by the processor to extrapolate end point information where either GPS tracking unit is disconnected from the system for a period of time.

14. The system according to claim 1, wherein the mobile device is configured to function as an RFID transponder capable of communicating with the base station.

15. The system according to claim 18, wherein RFID communication is used to at least one of validate or determine the start point, validate or determine the end point, and authorize boarding.

16. The system according to claim 1, wherein the vehicle is one of a bus, a taxi, a train, a subway, a ferry, and a plane.

17. The system according to claim 1, wherein the determination of the start point is based on the passenger location and vehicle location aligning for over a given distance or time.

18. The system according to claim 1, wherein the determination of the end point is based on the passenger location and vehicle location misaligning over a given distance or time.

19. The system according to claim 1, wherein the relative location of the passenger relative to the vehicle is used to rout a transportation vehicle to a passenger requiring transportation services.

20. The system according to claim 1, wherein the processor is associated with a server and wherein the system is network-based.

21. A method for tracking transportation of passengers the method comprising:
a. using a mobile device, associated with a passenger and including a Global Positioning System (GPS) tracking unit, to detect location data for the passenger;
b. using a base station, associated with a transportation vehicle and including a GPS tracking unit, to detect location data for the transportation vehicle;
c. transmitting the passenger location data and the transportation vehicle location data to a processor;
d. using the passenger location data and the transportation vehicle location data to monitor a relative position of the passenger relative to the transportation vehicle; and
e. using the relative position of the passenger relative to the vehicle to determine information relating to at least one of: (i) a start point for the passenger traveling via the transportation vehicle and (ii) an end point for the passenger traveling via the transportation vehicle.
